(19) United States
(12) Patent Application Publication
(10) Pub. No.: US 2024/0191766 A1
(43) Pub. Date: Jun. 13, 2024

(54) FRICTION PAD, FRICTION PLATE, AND PROCESS FOR MANUFACTURING A FRICTION PLATE

(71) Applicant: Schaeffler Technologies AG & Co. KG, Herzogenaurach (DE)

(72) Inventor: Benjamin Baerwald, Kuppenheim (DE)

(73) Assignee: Schaeffler Technologies AG & Co. KG, Herzogenaurach (DE)

(21) Appl. No.: 18/288,077

(22) PCT Filed: Feb. 28, 2022
(86) PCT No.: PCT/DE2022/100164

§ 371 Date: Oct. 24, 2023

(30) Foreign Application Priority Data
Apr. 28, 2021 (DE) 10 2021 110 830.6

(51) Int. Cl. F16D 69/04; F16D 69/00

(52) U.S. Cl. CPC F16D 69/0408; F16D 2069/004; F16D 2069/0466; F16D 2250/0023; F16D 2250/0069

(57) ABSTRACT

A friction pad includes a fastening surface, a friction surface facing away from the fastening surface, a shape delimited by a peripheral cutting edge, and a base rim extending along the peripheral cutting edge. The base rim is more compressed than a remainder of the friction pad. The reminder of the friction pad has a pad height and the base rim may have a base height that is at least one quarter of the pad height. The base rim may have a base width that is at least as large as the pad height.

### CROSS-REFERENCE TO RELATED APPLICATIONS

This application is the United States National Phase of PCT Appln. No. PCT/DE2022/100164 filed Feb. 28, 2022, which claims priority to German Application No. DE102021110830.6 filed Apr. 28, 2021, the entire disclosures of which are incorporated by reference herein.

### TECHNICAL FIELD

The present disclosure relates to a friction pad having a fastening surface and a friction surface which faces away from the fastening surface and has a shape delimited by a peripheral cutting edge. The disclosure further relates to a friction plate having at least one such friction pad. The disclosure further relates to a process for manufacturing such a friction plate.

### BACKGROUND

From the German patent application DE 10 2017 124 330 A1, a wet-running multi-plate clutch with clutch plates is known, which is non-rotatably connected, but displaceable in the axial direction, to a plate carrier that has fluid passage openings. At least one of the clutch plates has radially inwardly and/or radially outwardly at least one recess through which a fluid flow through a nearby fluid passage opening in one of the plate carriers is improved. The German patent application DE 10 2013 010 651 A1 discloses a wet clutch device with a closed clutch housing and at least one clutch plate arranged in the clutch housing. The wet clutch has a plate carrier and at least two friction pads which are arranged on the plate carrier, are spaced apart from one another in the peripheral direction and delimit a coolant duct which leads at least essentially in the radial direction and is inclined in the peripheral direction at least in a partial region.

### SUMMARY

The present disclosure functionally improves a friction pad having a fastening surface and a friction surface which faces away from the fastening surface and has a shape delimited by a peripheral cutting edge.

The present disclosure provides a friction pad having a fastening surface and a friction surface facing away from the fastening surface, which has a shape delimited by a peripheral cutting edge. The friction pad has a base rim that extends along the peripheral cutting edge and is more compressed than the friction pad within the base rim. The friction pad may be formed from a friction lining material containing fibers. The friction lining material with the fibers resembles a raw material used in the manufacture of paper. Therefore, the friction lining material is also referred to as paper material and also as paper for short.

During operation, the friction pad comes into contact with a coolant, such as oil. The friction pad is therefore also referred to as a wet-running friction pad. Analogously, the paper from which the friction pad is formed is also referred to as wet-running paper. The friction pad is separated from the friction lining material along its cutting edge, for example by punching. However, the friction pad can also be cut out of the friction lining material in some other way. When cutting out or punching, for example with inexpensive tools, it can happen that the friction pad tears or that fibers are torn out of the wet-running paper. If parts and/or fibers of the friction pad attached to a carrier element become detached, this is also referred to as delamination.

Due to the more strongly compressed base rim of the friction pad, delamination during operation of a friction plate equipped with the friction pad can be effectively prevented or at least significantly reduced. The strength of the friction pads can be effectively increased because the damaged area on the cutting edge is strengthened by the all-round embossing and defects are eliminated. In addition, drag torques can be reduced during operation of the friction plate equipped with the friction pad, since it is not the fibrous cutting edge but an embossed, rounded edge that comes into contact with a steel plate, for example. Depending on the design, it is accepted in a known manner that a base area of the friction pad is enlarged by the base rim.

In an exemplary embodiment of the friction pad, the base rim has a base height that corresponds to at least a quarter of a pad height of the friction pad. Dimensions of the friction pad transversely to the fastening surface or friction surface are referred to as pad height and base height, and the fastening surface is arranged parallel to the friction surface. With the claimed base height, the friction pad can also be attached to the carrier element in a sufficiently stable manner in the area of the base rim.

In another exemplary embodiment of the friction pad, the base rim has a base width that is at least as great as the pad height of the friction pad. A dimension of the base rim transverse to the cutting edge is referred to as width. With the claimed base width, a sufficiently stable attachment of the friction pad can also be ensured in the area of the base rim on the carrier plate.

In a further exemplary embodiment of the friction pad, the base rim is designed as a peripheral step which, in cross section, has a first leg angled from the friction surface, from which a second leg is angled, which represents the base rim. From an end of the second leg facing away from the first leg, the cutting edge is then angled, which is produced, for example, when punching on the friction pad. The shape of the friction pad can be implemented in almost any way. The peripheral step extends along the entire cutting edge on the friction pad.

In another exemplary embodiment of the friction pad, angles between the friction surface and the first leg and between the first leg and the second leg are between 90 and 120 degrees. This has proven to be advantageous with regard to the desired function and with regard to the production of the friction pad and the production of a friction plate with the friction pad.

In another exemplary embodiment of the friction pad, a radius of curvature is formed between the friction surface and the first leg. Among other things, this provides the advantage that no fibrous cutting edge or sharp edge occurs in a contact area or a contact surface between the friction pad and a steel plate that comes into contact during operation of a friction clutch equipped with the friction plate and the friction pad. As a result, the wear on the friction pad during operation of the friction clutch, in particular a multi-plate clutch, can be effectively reduced.

In another exemplary embodiment of the friction pad, a radius of curvature is formed between the first leg and the second leg. This radius of curvature has proven to be advantageous with regard to a coolant flowing around the friction pad.

In another exemplary embodiment of the friction pad, the radius of curvature has a size between one tenth and one millimeter. The claimed size of the radius of curvature advantageously relates both to the radius of curvature between the friction surface and the first leg and to the radius of curvature between the first leg and the second leg.

The present disclosure further relates to a friction plate having at least one friction pad as described above. The friction plate may include a carrier plate onto which a multiplicity of friction pads described above are adhered. All friction pads have a base rim. However, it is also possible that only some friction pads, i.e. not all of the friction pads of the friction plate, have the base rim.

In a process for manufacturing a friction plate as described above, an intermediate pad product is punched out of a covering material in a punching process before the punched-out intermediate pad product is adhered onto a carrier element in a subsequent adhesive process. The base rim is embossed into the intermediate pad product during the adhesive process. Fibers can be pulled out at a cutting edge from the punching, which is undesirable in itself, because this results in preliminary damage to the friction pad. By embossing the edge of the base, the previously damaged area may be compressed to such an extent that open areas in or on the cutting edge of the friction pad are closed.

Due to the peripheral embossing produced during adhesion, the friction lining material, e.g., a wet-running paper, is heavily compressed or compacted in the area damaged during the punching, which increases the strength of the friction pad on the carrier element. This results in an embossed contour without sharp cutting edges on the contact surface of the friction pad that comes into contact with the steel plate during operation or on its side surface. In this way, the drag torque can be effectively reduced while at the same time reducing the risk of delamination. Among other things, the claimed solution allows for groove patterns or groove designs that can be realized with smaller friction pads.

### BRIEF DESCRIPTION OF THE DRAWINGS

Further advantages, features and details of the present disclosure are apparent from the following description, in which various exemplary embodiments are described in detail with reference to the drawing. In the figures:

FIG. 1 shows a perspective view of a friction plate having a carrier element to which friction pads with an embossed base rim are fastened: and

FIG. 2 is a sectional view along a line II-II in FIG. 1.

### DETAILED DESCRIPTION

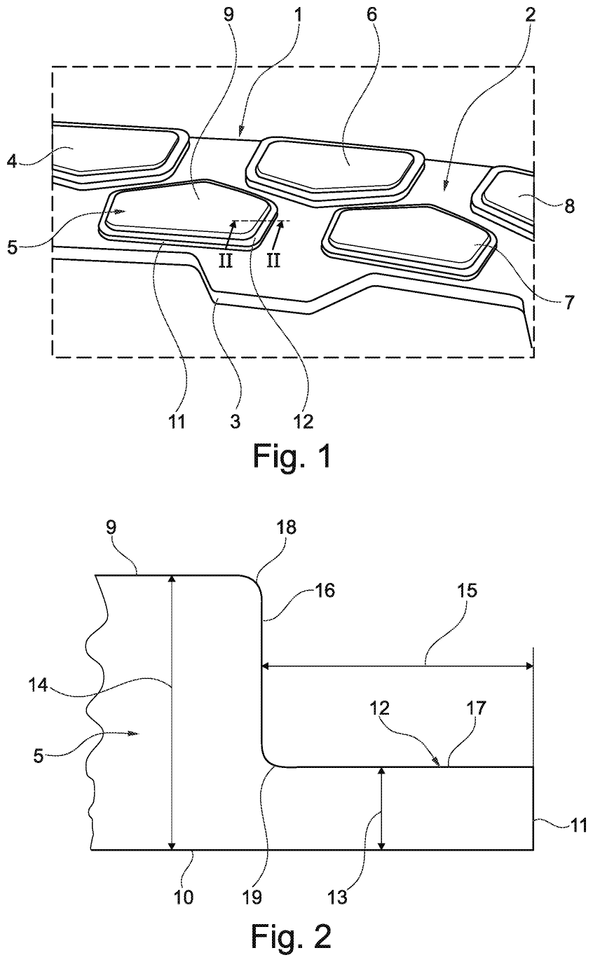

FIG. 1 shows a perspective representation of a friction plate 1 having a carrier element 2. The carrier element 2 has the shape of a circular ring disc. Radially inwardly, the carrier element 2 has an internal toothing 3.

The internal toothing 3 on the carrier element 2 is used to create a non-rotatable connection with a plate carrier (not shown in FIG. 1), of a multi-plate clutch which has friction plates 1 and steel plates in alternation. The steel plates are brought into frictional contact with the friction plates 1 in order to transmit torque. The structure and function of such multi-plate clutches are known.

Friction pads 4, 5, 6, 7, 8 are attached to the carrier element 2. The friction pads 4 to 8 all have the same pentagonal shape. The friction pads 4 to 8 are arranged in two rows. The friction pads 4 to 8 may be arranged in the same way or in a similar way to that disclosed in the international patent applications WO 2018/171834 A1 and WO 2018/171835 A1.

The friction pad 5 includes friction surface 9 arranged at the top in FIG. 1. The friction pad 5 is adhered to the carrier element 2 with a fastening surface 10 facing away from the friction surface 9. The friction pad 5 is punched out of a paper-like friction lining material.

A cutting edge 11 produced during punching, for example, delimits the pentagonal shape of the friction pad 5. The friction pad 5 has a base rim 12 along the cutting edge 11. In the area of the base rim 12, the friction pad 5 is more compressed than inside the base rim 12.

In FIG. 2, the view of a section along a line II-II in FIG. 1 is shown enlarged. A base height is denoted by a double arrow 13 in the sectional view of FIG. 2. A pad height is denoted by a double arrow 14. A base width is denoted by a double arrow 15.

The pad height 14 is significantly greater than the base height 13 in the area of the base rim 12, which is more compressed. The friction pad 5 is equipped with a peripheral step to show the base rim 12 viewed in cross section.

The step includes a first leg 16 which is angled from the friction surface 9. A second leg 17 is angled from the first leg 16. The second leg 17 serves to represent the base rim 12. The cutting edge 11 is in turn angled from the second leg 17.

The friction surface 9 is arranged parallel to the base rim 12. The second leg 17 is arranged parallel to the cutting edge 11 when viewed in the cross section shown. A right angle is formed between the friction surface 9 and the first leg 16. A right angle is also formed between the two legs 16, 17.

A radius of curvature 18 is provided between the friction surface 9 and the first leg 16. A radius of curvature 19 is provided between the first leg 16 and the second leg 17.

### REFERENCE NUMERALS

1 Friction plate
2 Carrier element
3 Internal toothing
4 Friction pad
5 Friction pad
6 Friction pad
7 Friction pad
8 Friction pad
9 Friction surface
10 Fastening surface
11 Cutting edge
12 Base rim
13 Base height
14 Pad height
15 Base width
16 First leg
17 Second leg
18 Radius of curvature
19 Radius of curvature

1. A friction pad having a fastening surface and a friction surface which faces away from the fastening surface and has a shape delimited by a peripheral cutting edge, wherein the friction pad has a base rim that extends along the peripheral cutting edge and is more compressed than the friction pad within the base rim.

2. The friction pad according to claim 1, wherein the base rim has a base height that corresponds to at least a quarter of a pad height of the friction pad.

3. The friction pad according to claim 2, wherein the base rim has a base width that is at least as large as the pad height of the friction pad.

4. The friction pad according to claim 1, wherein the base rim is designed as a peripheral step which, in cross section, has a first leg angled from the friction surface, from which a second leg is angled, which represents the base rim.

5. The friction pad according to claim 4, wherein angles between the friction surface and the first leg and between the first leg and the second leg are designed as angles between 90 and 120 degrees.

6. The friction pad according to claim 4, wherein a radius of curvature is formed between the friction surface and the first leg.

7. The friction pad according to claim 4, wherein a radius of curvature is formed between the first leg and the second leg.

8. The friction pad according to claim 6, wherein the radius of curvature has a size of between one tenth and one millimeter.

9. A friction plate having at least one friction pad according to claim 1.

10. A process for manufacturing a friction plate according to claim 9, wherein an intermediate pad product is punched out of a lining material in a punching process before the punched-out intermediate pad product is adhered onto a carrier element in a subsequent adhesive process, wherein the base rim is embossed into the intermediate pad product in the adhesive process.

11. A friction pad, comprising:
a fastening surface;
a friction surface facing away from the fastening surface;
a shape delimited by a peripheral cutting edge; and
a base rim extending along the peripheral cutting edge, the base rim being more compressed than a remainder of the friction pad.

12. The friction pad of claim 11 wherein:
the remainder of the friction pad comprises a pad height; and
the base rim comprises a base height that is at least one quarter of the pad height.

13. The friction pad of claim 12 wherein the base rim comprises a base width that is at least as large as the pad height.

14. The friction pad of claim 11 wherein the base rim is a peripheral step having a cross-section with:
a first leg angled from the friction surface; and
a second leg, representing the base rim, angled from the first leg.

15. The friction pad of claim 14 wherein:
a first angle between the first leg and the friction surface is between 90 and 120 degrees; and
a second angle between the second leg and the first leg is between 90 and 120 degrees.

16. The friction pad of claim 14 further comprising a first radius of curvature formed between the friction surface and the first leg.

17. The friction pad of claim 16 wherein a first radius of the first radius of curvature is between 0.1 and 1 mm.

18. The friction pad of claim 14 further comprising a second radius of curvature formed between the first leg and the second leg.

19. The friction pad of claim 18 wherein a second radius of the second radius of curvature is between 0.1 and 1 mm.

20. A friction plate comprising the friction pad of claim 11.
